(19) United States
(12) Patent Application Publication
(10) Pub. No.: US 2016/0239574 A1
(43) Pub. Date: Aug. 18, 2016

(54) DETERMINING AND MAINTAINING A LIST OF TOP NEWS STORIES FROM NEWS FEEDS

(71) Applicant: ACQUIRE MEDIA VENTURES INC., Roseland, NJ (US)

(72) Inventors: Lawrence C. Rafsky, Livingston, NJ (US); Jonathan Alan Marshall, Montclair, NJ (US); Raymond Sun, East Brunswick, NJ (US)

(21) Appl. No.: 14/742,135

(22) Filed: Jun. 17, 2015

Related U.S. Application Data
(60) Provisional application No. 62/115,260, filed on Feb. 12, 2015.

(51) Int. Cl. G06F 17/30; H04L 29/06

(52) U.S. Cl. CPC G06F 17/30867; H04L 67/42; G06F 17/3053

(57) ABSTRACT

Responsive to a server determining that at least one term of a story signature of a first news story matches at least one term of the story signature of a second news story of a list of top news stories derived from a set of first news feeds, the server may replace the second news story in the list with the first news story. The server may transmit to a client a set of top news stories from a set of second news feeds having stories which match one or more topics of the stories in the list of top news stories derived from the set of first news feeds.

### CROSS-REFERENCE TO RELATED APPLICATIONS

This application claims the benefit of U.S. provisional patent application No. 62/115,260 filed Feb. 12, 2015, the disclosure of which is incorporated herein by reference in its entirety.

### TECHNICAL FIELD

Examples of the present disclosure relate to a method and system to find currently relevant news stories from a plurality of news feeds and arrange them into a list of stories considered to be both newsworthy and relevant at the time of viewing, dubbed “top stories,” to be delivered to clients over a network.

### BACKGROUND

Generating a list of top news stories and, more particularly, identifying which news articles are “top,” or currently most relevant, is a difficult problem to solve. When attempting to generate a list of top news articles, populating the list with only articles about the most pressing topic defeats the purpose of having a list. Accordingly, the ability to detect duplicate stories and select the best story from the duplicates is needed. As news flow becomes thicker and thinner throughout the day, a metric other than real-time is needed to determine how relevant a news story is to a reader at any given point in time, since stories quickly rise to and decline from relevance when news traffic is thick while maintaining a more persistent level of relevance at slow news hours such as the very early morning. Real-time calculation of news relevance is ill-suited to adapt to fluctuations in news flow. Minimizing cost for the client is desirable. Ideally, a top news list sent to a client would have the most relevant news stories they could possibly receive while minimizing the cost that they pay for premium news wires.

### SUMMARY

The above-described problems are remedied and a technical solution is achieved in the art by providing a method to find currently relevant news stories from a plurality of news feeds and arrange them into a list of stories considered to be both newsworthy and relevant at the time of viewing, dubbed “top stories,” to be delivered to clients over a network. A server may receive a first news story belonging to a set of first news feeds (e.g., over a network, e.g., the Internet). In another example, the server may initiate pushing to the client the list of stories pertaining to the topic. In an example, the server initiating pushing to the client the list of stories pertaining to the topic may be a scheduled event or triggered event.

In an example, a score for a news story may be based on a sum of the terms that appear most prominently in the news story (e.g., a story signature of the news story). As used herein, the term “story signature” may refer to a short set of words or phrases, sometimes truncated or stemmed, that represent the key concepts in a story. The short set of words or phases may, in an example, comprise 5 to 15 constituents. The short set of words or phases are often made up of two different sub-signatures: A “headline signature”, which derives the short set of words or phases from headlines, and “cluster signature”, derives the short set of words or phases from the opening paragraphs of a story as a single cluster of information. As used herein, the term overlap may refer to a measure of the degree that two stories are on the same topic by looking at the overlap of components of the story signature. As used herein, the short set of words or phrases that represent the key concepts in a story may be referred to as the story signature, headline signature, or cluster signature.

In an example, the set of first news feeds may comprise a set of premium cost news feeds. Responsive to the server determining that at least one term of the story signature of the first news story matches at least one term of the story signature of a second news story of a list of top news stories derived from the set of first news feeds, the server may replace the second news story in the list with the first news story. The server may receive a request from a client for the list of top news stories or the server may initiate pushing to the client the list of top news stories. The server may transmit to the client a set of top news stories from a set of second news feeds having stories which match one or more topics of the stories in the list of top news stories derived from the set of first news feeds.

In an example, a feed may belong to a set of driver news feeds (e.g., premium cost news feeds), a set of candidate news feeds (e.g., low cost or free news feeds), both the set of driver news feeds and the set of candidate news feeds, or neither the set of driver news feeds and the set candidate news feeds. In an example, the set of first news feeds may be a subset of the set of second news feeds. In an example, the set of first news feeds may be a set of low cost or free news feeds and the set of second news feeds may comprise a set of premium cost news feeds.

In one example, the server replacing the second news story with the first news story may comprise the server calculating a first score of the first news story based on the scores assigned to the story signature terms of the first news story. The server may further calculate a second score of the second news story based on the scores assigned to the story signature terms of the second news story. Responsive to the first score being greater than the second score, the server replaces the second news story in the list with the first news story; otherwise, the first news story may be dropped. In one example, the first score may be equal to a score corresponding to the sum of the scores of the story signature terms in the first news story.

In one example, a score of a term in the story signature of the first news story may be incremented each time the term appears in a story. In an example, a term in the story signature of the second news story may decrease in score each time a news story is published in the set of first news feeds or the set of second news feeds.

In an example, responsive to the server determining that at least one story signature term of the first news story matches at least one story signature term of a third news story, and that at least one story signature term of the second news story matches at least one story signature term of the third news story of a list of top news stories derived from the set of first news feeds (not necessarily the same term), the server may calculate a first score of the first news story based on the scores assigned to story signature terms in the first news story. The server may further calculate a second score of the second news story based on the scores assigned to story signature terms in the second news story. The server may further calculate a third score of the third news story based on the scores assigned to story signature terms in the third news story. Responsive to the third score being greater than the sum of the first score and the second score, the server may replace the first news story and the second news story in the list with the third news story; otherwise, the third news story may be dropped.

In an example, the server may receive a third news story belonging to the set of first news feeds. The server may calculate a score of the third news story based on the scores assigned to story signature terms in the third news story. Responsive to the third news story having a greater score than at least one of the news stories in the list and the third news story having no story signature terms that overlap with story signature terms in any of the news stories in the list, the server may add the third news story to the list and drop the lowest scoring news story from the list.

In an example, the server may receive a third news story belonging to the set of first news feeds. Responsive to of list of top news stories having fewer than a maximum number of stories, the server may add the third news story to the list.

In an example, when the number of stories in the list is below a maximum, the server may add one or more runner-up stories (e.g., stories having a score just below the lowest score in the list) to the list.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 is a block diagram of an example system in which examples of the present disclosure may operate.

FIG. 2 is a block diagram of an example of scores calculated by the system of FIG. 1.

FIG. 3 is a block diagram of an example of operations performed with the system of FIG. 1.

FIG. 4 is a flow diagram illustrating an example of a method to find currently relevant news stories from a plurality of news feeds and arrange them into a list of stories considered to be both newsworthy and relevant at the time of viewing, dubbed “top stories,” to be delivered to clients over a network.

FIG. 5 illustrates a diagrammatic representation of a machine in the exemplary form of a computer system within which a set of instructions, for causing the machine to perform any one or more of the methodologies discussed herein, may be executed.

It is to be understood that the attached drawings are for purposes of illustrating the concepts of the invention and may not be to scale.

### DETAILED DESCRIPTION

Examples of the present disclosure are adapted to generate a top news list. Examples of the present disclosure relate to finding currently relevant news stories and arrange them into a list of stories considered to be both newsworthy and relevant at the time of viewing, dubbed “top stories,” to be delivered to clients. Examples of the present disclosure can identify top stories using premium wires (e.g. Associated Press, etc.) and then use that information to identify top stories from other news wires (which might be lower cost) on the same topics. The lower-cost stories can be delivered to the customers instead. In this way, the importance of the news may be calculated using a set of premium wires which may collectively carry a more comprehensive, more balanced, and deeper set of news stories, but the client or distributor does not pay the extra amount to receive the news. Examples of the present disclosure also maintain a temporal relevance score, such that newer stories are more likely to be rated as top news.

A distinction of examples of the present disclosure from other relevance algorithms is by viewing the passing of time by referring to the number of stories published, rather than real-time. Thus, topics covered during periods of high news volume can gain or lose their top news status quicker than during periods of low news volume.

In one example, only one story on a given topic may be present in the top list. This prevents duplicate stories from making it onto the top list so a more comprehensive representation may be given of the day's events, while still ensuring that all the represented topics are indeed relevant.

In another example, a plurality of news stories on a given topic may be present in the top list.

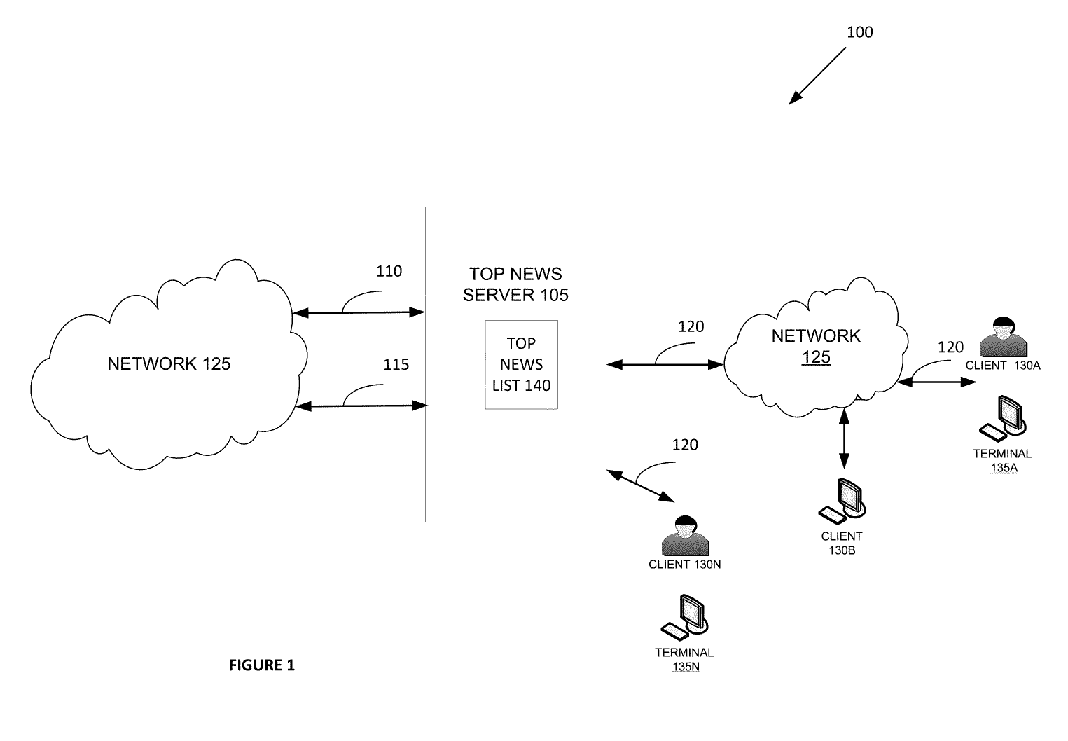

FIG. 1 is a block diagram of an example system 100 in which examples of the present disclosure may operate. A top news server 105 may be configured to receive news stories, for example, over a network 125, which may be, but is not limited to, the Internet. The news stories may be separated into two categories: “topic-driving” feeds 110 from the premium wires and lower-priced or free “candidate” feeds 115.

One or more clients 130a-130n may receive on a terminal (e.g., 135a) e.g., over the network 125 or directly from a terminal 135n communicatively connected to the top news server 105, a set of top news stories 120. A client (e.g., 130a) may be, for example a human user, operator, or customer of the system 100, or may be a non-terminal automated client application (e.g., 130b) as part of a client server relationship communicatively connected to the network 125 or to the top news server 105 using an application programming interface (API). A topic may be a specific company, say IBM. The topic(s) in a given story may be identified during preprocessing by the top news server 105. If a story mentions IBM, the top news server 105 may consider the term IBM for the IBM topic.

A list of top news stories 140 may be maintained from the candidate feeds 115. The top news stories in the list 140 may each be rated in relevance based on, e.g., eight or so terms, which feature most prominently in the story (called a story signature). Each individual term in the story signature may have its own score, which may increase each time a news story with that term is published in a topic-driving feed 110. However, the individual term score may decay by a small percentage each time a news story in a topic-driving feed 110 is published. The decay of term scores permits more relevant news stories to replace the older ones continuously, even when the older ones were highly relevant at the time of their release. If a story signature term is appearing in many stories over a short period of time, the term is likely to be related to a top news story. A term that appears frequently, but over a longer period of time, may still be relevant. However, it may be less relevant because fewer publications transmitted stories with the term as soon as possible.

The score for a specific story may be created using the sum of the scores from its story signature terms. After that, if the specific story is fit to be sent to the client (e.g., 130a) (that is, it is from a feed on the list of candidate feeds 115), the specific story may be considered for the list of top news stories 140, where its story score may be generated using the sum of the scores from the individual terms in its story signature. In an example, if the specific story overlaps (e.g., shares one or more story signature terms in common) in story signature terms with another story on the list of top news stories 140, the specific story may be rejected unless it has a higher story score than that story. If the specific story overlaps with multiple stories on the list of top news stories 140, then the specific story may need to have a higher story score than all of the overlapping stories combined, or the specific story may be rejected. In another example, if the specific story overlaps with multiple stories on the list of top news stories 140, then the specific story may need to have a higher story score than one of the overlapping stories, or the specific story may be rejected. In another example, if the specific story overlaps with multiple stories on the list of top news stories 140, then the specific story may need to have a higher story score than a range between one overlapping story and the all overlapping stories, or the specific story may be rejected.

In one example, in the event that the specific story does have a score that exceeds that of every overlapping story on the list of top news stories 140, all of those overlapping stories may be removed from the list. In another example, in the event that the specific story does have a score that exceeds the highest scoring overlapping story on the list of top news stories 140, all those overlapping stories may be removed from the list. In this way, stories sharing story signature terms in common are likely to cover the same topic. To avoid duplication across the list of top news stories 140, a story which is more relevant than a second story (i.e., contains more currently relevant terms found in other stories) may be kept, and the second story may be dropped. Occasionally, if multiple stories are removed at once, the list of top news stories 140 may become smaller than its maximum size. In this event, runner-up stories may be added to the list of top news stories 140. If the specific story bears no overlap in story signature with any of the other stories on the list of top news stories 140 and has a greater story score than any story on the list of top news stories 140, the specific story may be included while the lowest-scored story on the list of top news stories 140 may be dropped. If the list of top news stories 140 is not fully populated, an incoming story may be added automatically as long as it does not overlap with any existing stories on the list of top news stories 140.

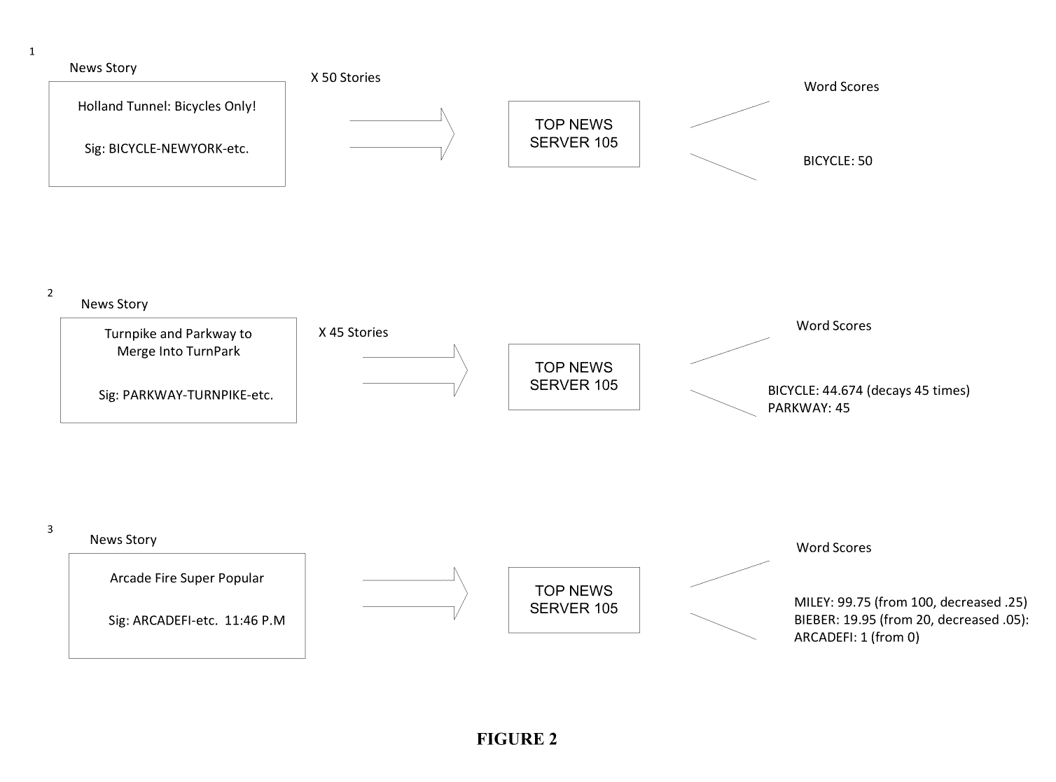

Scores are then decayed over time to ensure that old stories are not treated as relevant continuously. Referring to FIG. 2, for example, if the mayor of New York City declared that the Holland Tunnel exit would now be accessible only via bicycle, the term. BICYCLE may be present in a large number of news stories, causing it to have a high word score. Later on in the day, the governor of New Jersey announces a project to merge the Garden State Parkway and the NJ Turnpike into one eight-lane highway named the “Turnpark”, which may cause a large number of stories containing the term PARKWAY to hit the press. Although there may be less news coverage of the Turnpark, there may still be enough stories to decay the term BICYCLE considerably. This reflects the relevance of the term, because if a story about the Holland Tunnel change containing the term BICYCLE is published after the Turnpark declaration, it is far less relevant than it was when the news was still fresh (and unchallenged by other news topics). Since the decay is based on the number of stories incoming, rather than time, this ensures that no term maintains an excessive score after its relevance has passed.

In another example, a news story concerning Miley Cyrus may occur early on in the day. If the decay was over a certain amount of time, it may be impossible to substantially decrease the score of the MILEY until the end of the day, even as newer, more relevant topics come in. However, using a story publication-based decay system, a term with a high score will depreciate in score quicker as more stories come in, ensuring that it cannot undeservedly maintain a hold on relevance throughout the course of the day.

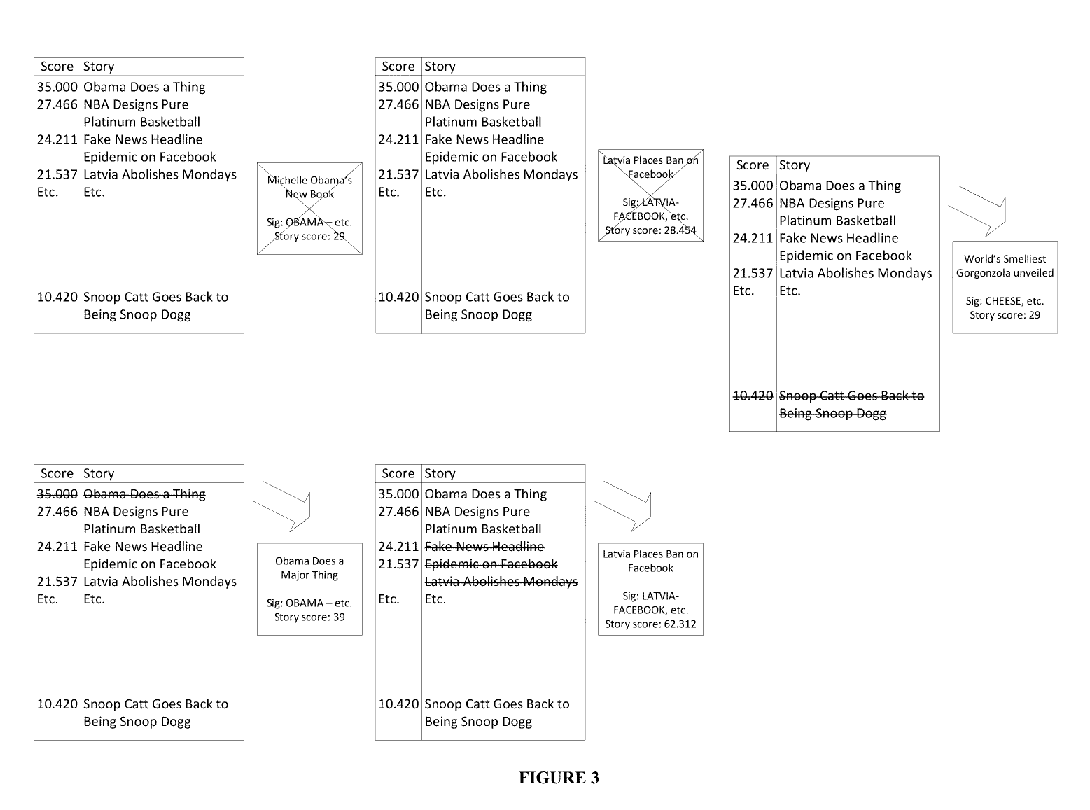

The elimination of stories with overlapping story signatures may be needed to determine which stories are truly top news stories. With stories that have a simple one-term overlap, the decision is easy: the higher-scored story goes on the list of top news stories 140. Referring to the example of FIG. 3, if Obama disappears from the country, an overwhelming majority of news publications would cover that story, bumping the term “OBAMA” to a very high score. Because the algorithm scores each story using the composite of all of its terms, whichever story about Korea was deemed most relevant (likely containing some other terms representative of the situation like “missing”) makes it onto the list of top news stories 140, while similar stories are left out because they had a shared term. This prevents a less-important story (e.g., “Michelle Obama's New Book”) from sharing the high-scoring “OBAMA” term. However, if Obama returned suddenly to the White House, such a story would receive even more publications, and subsequently would cause the removal of the story about Obama disappearing on the list of top news stories 140.

In one example, when a first story overlaps with two or more existing stories, the score of the first story needs to exceed the combined scores of all overlapping stories to be placed on the list of top news stories 140. In one example, the top news server 105 may maintain a non-overlapping list (e.g., the list of top news stories 140) to prevent multiple stories on the same topic. In another example, the top news server 105 may maintain a partially overlapping list (e.g., the list of top news stories 140), but avoid multiple stories on the same topic on the partially overlapping list to prevent multiple stories on the same topic. Finally, non-overlapping challenging stories are handled as follows: if the score of the non-overlapping challenging stories exceeds any story on the list of top news stories 140, the non-overlapping challenging stories may enter the list of top news stories 140 and the lowest scored story on the list of top news stories 140 may exit the list of top news stories 140.

Temporal relevance may be calculated by the system 100 as follows. In addition to the word score decay, which permits once-high scoring topics to be replaced as they become less relevant, the system 100 may employ the publication of a news story as a unit of time, rather than real-time. This is an improvement over using the news story's own temporal metadata (e.g., a time-stamp related to but external to the news story itself) to calculate how relevant the news story is because the system 100 adjusts for the rate of news publication. For example, during the middle of the day, more news-worthy topics tend to occur, and the system 100 should reflect that news can quickly become less relevant as other topics are determined, even though little time may have actually passed. In the middle of the night, less of interest is published, so if a newsworthy topic is determined at that point, it should remain relevant for longer, since there are fewer newsworthy topics at that point in time overall. The system 100 may account for unexpected influences on news trends, such as a sudden declaration of war by a major world power. Such an event, as well as events resulting from the consequences of such a declaration, may be the most relevant topic the moment the event happened. In a real-time algorithm, if something newsworthy but less important (e.g., the Oscars) had happened just prior, it would be more difficult to remove it from the list of top news stories 140 in favor of the new trending topic because it would technically still be very recent news. However, using the system 100, the Oscar story(s) would decay in relevance quickly because of the bulk of publications concerning the war declaration, better reflecting the shift in news focus which just occurred.

After the list of top news stories 140 is established, the clients 130a-130n may request the top news stories 120 at any time. In another example, the server 105 may initiate pushing to one or more clients 130a-130n the list of the top news stories 140. The trigger for initiating pushing the list of the top news stories 140 to the clients 130a-130n may be a scheduled event, e.g., on an hourly schedule, or a triggered event, e.g., when a new story enters the list of the top stories 140.

In an example, if list of top news stories 140 has been filled using non-premium feeds 115 (i.e. whichever feeds the client (e.g., 130a) may use), the consent of the premium feed providers may be sought for using their information. However, the word count which drives the story score may use premium feeds 110 that are chosen for their quality as indicators of news relevance. That way, the client (e.g., 130a) may receive a feed 120 composed of stories which they are permitted to access but with the newsworthiness assurance of the highest-tiered feeds 110. The list of top news stories 140 may be updated each time a viable story comes in using the calculated word scores, meaning there is essentially no delay in calculating the relevance of a story and transmitting it, even though two separate lists, one of stories to be sent to the client (e.g., 130a) and one of words indicating relevant topics, may be maintained. The client (e.g., 130a) may also request to see up to a given number of stories about each topic, so that the client (e.g., 130a) may search through the reduced pool of stories to see which ones are relevant. The lists of candidate feeds 115 and topic-driving feeds 110 may be maintained and updated, so that the system 100 is adaptable, quick, and provides the client (e.g., 130a) with the highest quality information with no complications.

Additionally, the transmission of relevant stories may be delayed by a flat amount of time or until a certain point in time. This feature is particularly useful if the client (e.g., 130a) lacks the time or resources to continuously determine the list of top stories 140 while still wanting to know what topics were of relevance during the day at a later point in time. Delaying the transmission of a story also benefits the client (e.g., 130a) in that, while client (e.g., 130a) may not receive the news immediately, the system 100 may be provided with time to obtain a matching story from a non-premium feed that may match the premium story closer than simply the first non-premium story transmitted. In another example, the client (e.g., 130a) may elect to have stories conflict with each other if the stories have a set number “n” of story signature terms which overlap, rather than overlapping by one term. This permits more leniency for stories with similar topics making it to the list of top news stories 140. Following from that, the system 100 can also permit multiple stories with a given key word to populate the list of top news stories 140 (for example, if the client (e.g., 130a) is particularly interested in RUSSIA or SPORTS).

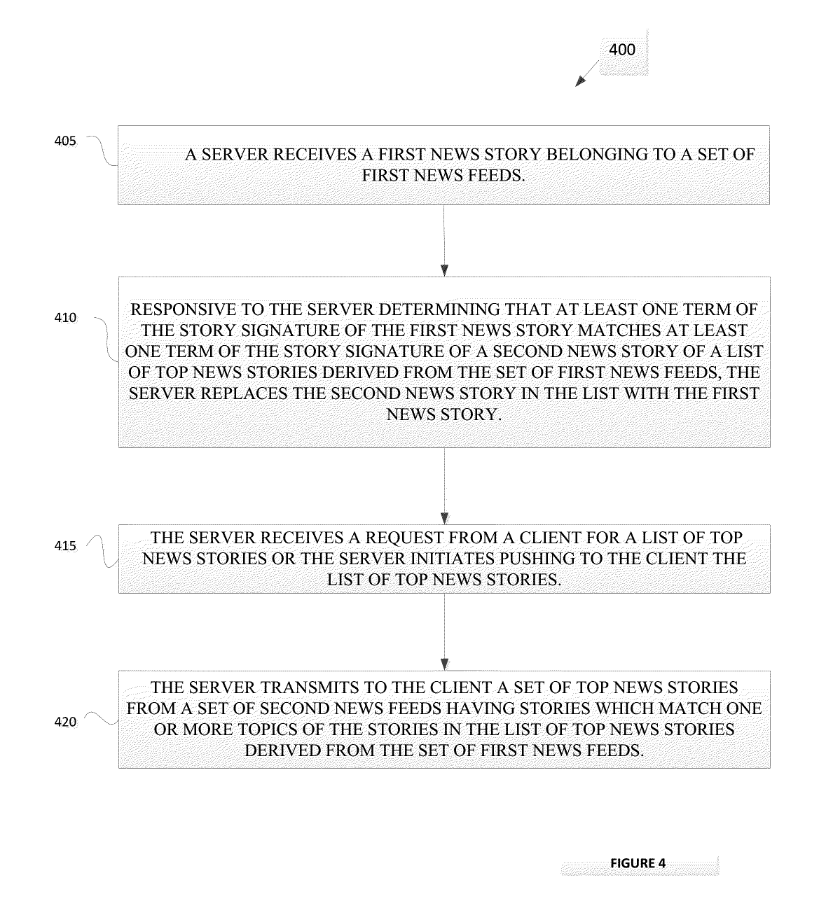

FIG. 4 is a flow diagram illustrating an example of a method 400 to find currently relevant news stories 140 from a plurality of news feeds 110, 115 and arrange them into a list of stories 140 considered to be both newsworthy and relevant at the time of viewing, dubbed “top stories,” to be delivered to clients 130a-130n over a network 125. The method 400 may be performed by at least one processor of the server 105 of FIG. 1 and may comprise hardware (e.g., circuitry, dedicated logic, programmable logic, microcode, etc.), software (e.g., instructions run on a processing device), or a combination thereof. In one example, the method 400 may be performed by processing logic 522 of the processor of the server 105 of FIG. 1.

As shown in FIG. 4, at block 405, the server 105 may receive a first news story belonging to a set of first news feeds 110 (e.g., over a network 125, e.g., the Internet). In an example, the set of first news feeds 110 may be a set of driver news feeds, e.g., a set of premium cost news feeds.

At block 410, responsive to the server 105 determining that at least one term of the story signature of the first news story matches at least one term of the story signature of a second news story of a list of top news stories 140 derived from the set of first news feeds 110, the server 105 may replace the second news story in the list 140 with the first news story.

At block 415, the server 105 may receive a request from a client for the list of top news stories) (e.g., from a terminal e.g., 135a over the network 125) or the server 105 may initiate pushing to the client (e.g., 130a) the list of top news stories 140. At block 420, the server 105 may transmit (e.g., over the network 125) to the client (e.g., 130a) a set of top news stories 120 from a set of second news feeds 115 having stories which match one or more topics of the stories in the list of top news stories 140 derived from the set of first news feeds 110. In an example, the set of second news feeds 115 may be a set of low cost or free news feeds (e.g., candidate news feeds).

In an example, the set of first news feeds may be a subset of the set of second news feeds. In an example, a feed may belong to the set of driver news feeds, the set of candidate news feeds, both the set of driver feeds and the set of candidate news feeds, or neither the set of driver news feeds and the set of candidate news feeds. In an example, the set of first news feeds may be a subset of the set of second news feeds 115.

In one example, the server 105 replacing the second news story with the first news story may comprise the server 105 calculating a first score of the first news story based on scores assigned to the story signature terms of the first news story. The server 105 may further calculate a second score of the second news story based on the scores assigned to the story signature terms of the second news story. Responsive to the first score being greater than the second score, the server 105 may replace the second news story in the list of top news stories 140 with the first news story; otherwise, the first news story may be dropped. In one example, the first score may be equal to a score corresponding to the sum of the scores of the story signature terms in the first news story.

In one example, a score of a term in the story signature of the first news story may be incremented each time the term appears in a story. In an example, a term in the story signature of the second news may decrease in score each time a news story is published in the set of first news feeds 110 or the set of second news feeds 115.

In an example, responsive to the server 105 determining that at least one story signature term of the first news story matches at least one story signature term of the second news story, and that at least one story signature term of the second news story matches at least one story signature term of a third news story of a list of top news stories 140 derived from the set of first news feeds 110 (not necessarily the same term), the server 105 may calculate a first score of the first news story based on the scores assigned to story signature terms in the first news story. The server 105 may further calculate a second score of the second news story based on the scores assigned to story signature terms in the second news story. The server 105 may further calculate a third score of the third news story based on the scores assigned to story signature terms in the third news story. Responsive to the third score being greater than the sum of the first score and the second score, the server 105 may replace the first news story and the second news story in the list of top news stories 140 with the third news story; otherwise, the third news story may be dropped.

In an example, the server 105 may receive a third news story belonging to the set of first news feeds 110. The server 105 may calculate a score of the third news story based on the scores assigned to story signature terms of the third news story. Responsive to the third news story having a greater score than at least one of the news stories in the list of top news stories 140 and the third news story having no story signature terms that overlap with story signature terms in any of the news stories in the list of top news stories 140, the server 105 may add the third news story to the list of top news stories 140 and drop the lowest scoring news story from the list of top news stories 140.

In an example, the server 105 may receive a third news story belonging to the set of first news feeds 110. Responsive to the list of top news stories 140 having fewer than a maximum number of stories, the server 105 may add the third news story to the list of top news stories 140.

In an example, when the number of stories in the list of top news stories 140 is below a maximum, the server 105 may add one or more runner-up stories to the list of top news stories 140.

In an example, the client (e.g., 130a) may be permitted to receive up to a selected number of stories about each topic in the set of second news feeds 115.

In an example, the server 105 transmitting to the client (e.g., 130a) the set of top news stories 120 may be delayed by a selected amount of time or until a certain point in time.

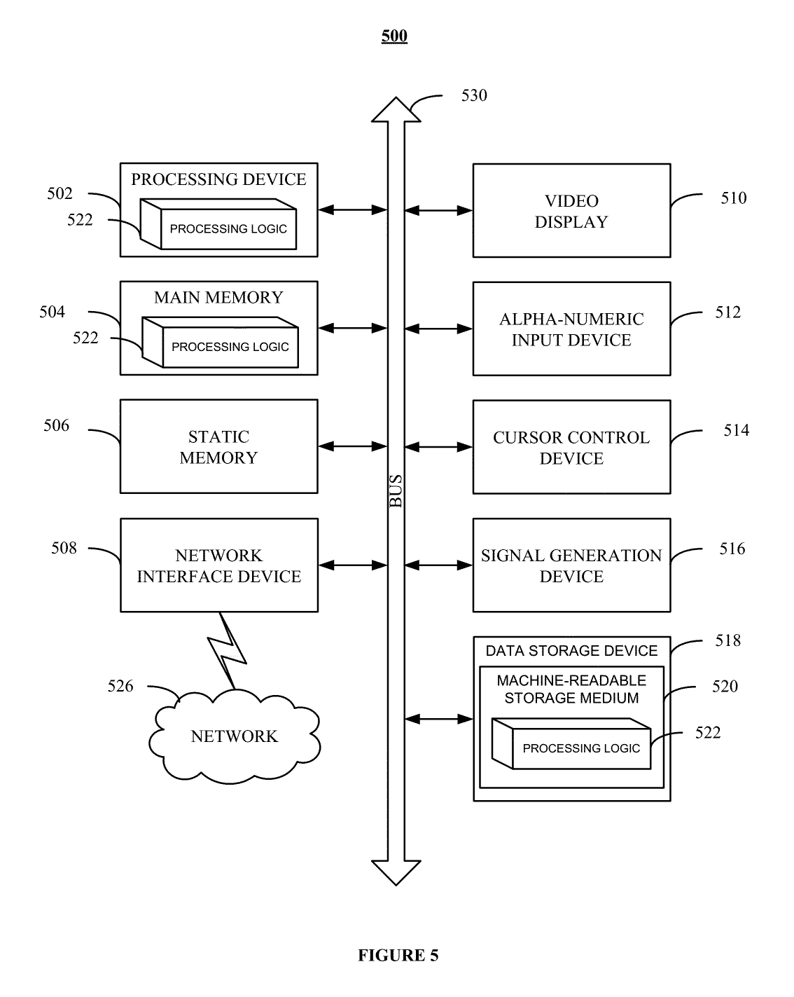

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. Processing device 502 is configured to execute processing logic 522 for performing the operations and steps discussed herein.

Computer system 500 may further include a network interface device 508. Computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

Data storage device 518 may include a machine-readable storage medium (or more specifically a computer-readable storage medium) 520 having one or more sets of instructions embodying any one or more of the methodologies of functions described herein. Device logic of may also reside, completely or at least partially, within main memory 504 and/or within processing device 502 during execution thereof by computer system 500; main memory 504 and processing device 502 also constituting machine-readable storage media. Processing logic 522 may further be transmitted or received over a network 526 via network interface device 508.

Machine-readable storage medium 520 may also be used to store the processing logic 522 persistently. While machine-readable storage medium 520 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

It is to be understood that the above description is intended to be illustrative, and not restrictive. Many other examples will be apparent to those of skill in the art upon reading and understanding the above description. The scope of the disclosure should, therefore, be determined with reference to the appended claims, along with the full scope of equivalents to which such claims are entitled.

1. A method, comprising,
providing, by a server, a list of top news stories derived from a set of first news feeds, the list of top news stories comprising a first news story having a first story signature and a second news story having a second story signature;
receiving, by a server, a third news story having a third story signature and belonging to the set of first news feeds;
responsive to the server determining that at least one story signature term of the first news story matches at least one story signature term of the third news story, and that at least one story signature term of the second news story matches at least one story signature term of the third news story,
calculating, by the server, a first score of the first news story based on the scores assigned to story signature terms in the first news story;
calculating, by the server, a second score of the second news story based on the scores assigned to story signature terms in the second news story;
calculating, by the server, a third score of the third news story based on the scores assigned to story signature terms in the third news story;
responsive to the third score being greater than the sum of the first score and the second score,
replacing, by the server, the first news story and the second news story in the list with the third news story;
receiving, by the server, a request from a client for a list of top news stories or initiating pushing, by the server, to the client the list of top news stories; and
transmitting, by the server to the client, a set of top news stories from a set of second news feeds having stories which match one or more topics of the stories in the list of top news stories derived from the set of first news feeds.

2. The method of claim 1, wherein a feed belongs to a set of driver news feeds, a set of candidate news feeds, or both the set of driver news feeds and the set of candidate news feeds.

3. The method of claim 1, wherein the set of first news feeds is a subset of the set of second news feeds or the set of first news feeds overlaps with the set of second news feeds.

4. (canceled)

5. (canceled)

6. The method of claim 1, wherein a score of a term in the set of terms that appear most prominently in the first news story is incremented each time the term appears in a story.

7. The method of claim 1, wherein a term in the story signature of the second news story decreases in score each time a news story is published in the set of first news feeds or the set of second news feeds.

8. (canceled)

9. The method of claim 1, further comprising:
receiving, by a server, a fourth news story belonging to the set of first news feeds;
calculating, by the server, a score of the first news story, the second news story, and the third news story based on the plurality of scores assigned to corresponding terms that appear most prominently in the first news story, the second news story, and the third news story, respectively;
responsive to the fourth news story having a greater score than at least one of the news stories in the list and the first news story the second news story, and the third news story having story signature terms that overlap with story signature terms in any of the news stories in the list,
adding, by the server, the fourth news story to the list and dropping the lowest scoring news story from the list.

10. The method of claim 1, further comprising:
receiving, by a server, a fourth news story belonging to the set of first news feeds;
responsive to the list of top news stories having fewer than a maximum number of stories,
adding, by the server, the fourth news story to the list.

11. The method of claim 1, wherein, when the number of stories in the list is below a maximum,
adding, by the server, one or more runner-up stories to the list.

12. The method of claim 1, wherein a client is permitted to receive up to a selected number of news stories about each topic in the set of second news feeds.

13. The method of claim 1, wherein said transmitting is delayed by a selected amount of time or until a certain point in time.

14. A system, comprising:
a memory;
a server, operatively coupled to the memory, the server to:
provide a list of top news stories derived from a set of first news feeds, the list of top news stories comprising a first news story having a first story signature and a second news story having a second story signature;
receive a first news story having a third story signature and belonging to the set of first news feeds;
responsive to the server determining that at least one story signature term of the first news story matches at least one story signature term of the third news story, and that at least one story signature term of the second news story matches at least one story signature term of the third news story,
calculate a first score of the first news story based on the scores assigned to story signature terms in the first news story;
calculate a second score of the second news story based on the scores assigned to story signature terms in the second news story;
calculate a third score of the third news story based on the scores assigned to story signature terms in the third news story;
responsive to the third score being greater than the sum of the first score and the second score,
replace the first news story and the second news story in the list with the third news story;
receive a request from a client for a list of top news stories or initiating pushing, by the server, to the client the list of top news stories; and
transmit a set of top news stories from a set of second news feeds having stories which match one or more topics of the stories in the list of top news stories derived from the set of first news feeds.

15. The system of claim 14, wherein a feed belongs to a set of driver news feeds, a set of candidate news feeds, or both the set of driver news feeds and the set of candidate news feeds.

16. The system of claim 14, wherein the set of first news feeds is a subset of the set of second news feeds or the set of first news feeds overlaps with the set of second news feeds.

17. (canceled)

18. The system of claim 14, wherein a score of a term in the set of terms that appear most prominently in the first news story is incremented each time the term appears in a story.

19. The system of claim 14, wherein a term in the story signature of the second news story decreases in score each time a news story is published in the set of first news feeds or the set of second news feeds.

20. A non-transitory computer readable storage medium including instructions that, when executed by a server, cause the server to:
provide, by the server, a list of top news stories derived from a set of first news feeds, the list of top news stories comprising a first news story having a first story signature and a second news story having a second story signature;
receive, by a server, a third news story having a third story signature and belonging to the set of first news feeds;
responsive to the server determining that at least one story signature term of the first news story matches at least one story signature term of the third news story, and that at least one story signature term of the second news story matches at least one story signature term of the third news story,
calculate, by the server, a first score of the first news story based on the scores assigned to story signature terms in the first news story;
calculating, by the server, a second score of the second news story based on the scores assigned to story signature terms in the second news story;
calculate, by the server, a third score of the third news story based on the scores assigned to story signature terms in the third news story;
responsive to the third score being greater than the sum of the first score and the second score,
replace, by the server, the first news story and the second news story in the list with the third news story;
receive, by the server, a request from a client for a list of top news stories or initiating pushing, by the server, to the client the list of top news stories; and
transmit, by the server to the client, a set of top news stories from a set of second news feeds having stories which match one or more topics of the stories in the list of top news stories derived from the set of first news feeds.

21. The non-transitory computer readable storage medium of claim 20, wherein a feed belongs to a set of driver news feeds, a set of candidate news feeds, or both the set of driver news feeds and the set of candidate news feeds.

22. The non-transitory computer readable storage medium of claim 20, wherein the set of first news feeds is a subset of the set of second news feeds or the set of first news feeds overlaps with the set of second news feeds.

23. (canceled)

24. The non-transitory computer readable storage medium of claim 20, wherein a score of a term in the set of terms that appear most prominently in the first news story is incremented each time the term appears in a story.

25. The non-transitory computer readable storage medium of claim 20, wherein a term in the story signature of the second news story decreases in score each time a news story is published in the set of first news feeds or the set of second news feeds.
